(19) United States
(12) Patent Application Publication
(10) Pub. No.: US 2004/0015953 A1
(43) Pub. Date: Jan. 22, 2004

(54) Automatically updating software components across network as needed

(76) Inventor: Jonathan M. Vincent, Salt Lake City, UT (US)

Correspondence Address: R. Burns Israelsen, WORKMAN, NYDEGGER & SEELEY, 1000 Eagle Gate Tower, 60 East South Temple, Salt Lake City, UT, 84111, US

(21) Appl. No.: 09/811,977

(22) Filed: Mar. 19, 2001

(51) Int. Cl. G06F 9/445

(52) U.S. Cl. 717/173; 717/178; 709/221

(57) ABSTRACT

Updating software components that are required to appropriately process content data included in a data file. A computer having installed thereon certain software components obtains a data file that includes a required component list identifying the required software components and required versions thereof needed for processing the content data. The computer compares the information in the list with the software components already installed at the computer. The computer obtains an update table identifying network locations from which the required software components can be obtained. If the required component list includes software components not already installed at the computer, these required components are requested from the network locations identified in the update table. If the required component list includes new versions of required software components and only previous versions of the required software components are already, these new versions are requested from the network locations. In this manner, the computer obtains the software components required to process the content data. As a result software providing new functionality and other software upgrades can be efficiently distributed to a large number of users.

### BACKGROUND OF THE INVENTION

1. The Field of the Invention

The present invention relates generally to computer systems and computer networks, and more specifically to systems and methods for automatically updating computer software on a computer system.

2. Background and Related Art

One of the major costs of software (i.e., computer programs) is the cost of installation and maintenance. Services (support, distribution/installation, updating, and administration) make up the largest expenditure of total personal computer software costs while the cost of the software itself accounts for only a small portion of these total costs. Because of the cost of these services, many companies update their software infrequently. Another reason that these services may not be performed as often as needed is due to the impact on users because their computers are unavailable during this process and productivity is reduced.

Individual users also infrequently upgrade their software due to the time and cost involved. Moreover, individuals may often be unaware of new versions of software and may not be familiar enough with computers to feel comfortable purchasing or otherwise obtaining software and installing the software on their computers.

New or upgraded versions of computer software are being released frequently. Sometimes, the release of a new or upgraded version of software may be to correct bugs or to add new features or capabilities that were not available at the time of the original or most recent software release. When institutional or individual users fail to upgrade their software, they are unable to take advantage of such improvements.

A large number of computer users may not be aware that new versions or upgrades to a computer program have been released. For example, a user may not see the press releases related to a new version or upgrade to a program module. Moreover, the user may not have registered his program module with the software manufacturer and, thus, the manufacturer may have no way to contact the user regarding the upgrade.

New versions of software programs are often incremental and include only a few new or modified features. Because most users do not regularly obtain such new versions, a potentially large number of different versions of software are typically used by different users at any particular time. It may take months or as long as several years for a significant segment of the user population to obtain an upgrade that includes a particular new software feature.

The problem of the latency associated with distributing software upgrades to significant segments of the user population is particularly acute in industries such as web content development. When a provider of web content selects development software and content features that are to be used to generate content, the provider is hesitant to use new and innovative features of the development software if there is not at least a critical mass of users who have access to the corresponding client software needed to appropriately display or otherwise process the content For instance, if a new version of development software has a new three-dimensional graphics engine, the content provider may be unwilling to encode the content using the three-dimensional graphics engine or even obtain the new version if only a small percentage of the users who access the content have the corresponding new version of the client software. At the same time, users do not find it necessary to upgrade their client software to take advantage of new features if the corresponding new features of the development software are not being used by developers and content providers. Accordingly, both users and content providers frequently do not have the incentive to obtain and use new versions of client software and development software, respectively. This problem is experienced in any situation in which one user has little incentive to obtain a software upgrade until a significant number of other users have already obtained or used the upgrade.

There currently exist systems implemented on the Internet for causing client computers to obtain new versions of software. For example, if a user downloads a data file having a certain format, the user can be directed to a web site that has software for processing content data associated with the data file. In a specific example, if a user were to access an image file having a certain compression format, the client computer can be directed to a web site that provides current versions of browser software for decompressing the image file and displaying the image to the user.

This approach for upgrading software has several disadvantages. For instance, when the client computer downloads software in this manner, an entire program is downloaded, including all components. If the client computer were to have a previous version of the program, all components of the new version would be downloaded to the client computer without regard to whether the previous version of the program on the client computer already includes some software components that remain unchanged in the updated version. In other words, the entire new version of the program is transmitted to the client computer, even if most of the new version remains unchanged from the previous version. In addition, the client computer may be directed to obtain the new version even if the previous version already installed on the client computer is capable of processing the data file that has been accessed. In general, existing techniques for updating software on a client computer are not client-specific, are not well suited for incremental updates of specific software components in a program, proceed without regard to any previous version that may be installed on the client computer, and often result in large, lengthy, and unnecessary transmissions of updated software as entire programs are downloaded and installed. In order to avoid the latency associated with large downloads of entire programs, many users decide not to upgrade software in this manner.

In view of the foregoing, it is clear that existing techniques for updating software on computers are inadequate and hinders the rapid distribution of new versions of software. In addition, the difficulty in efficiently updating software prolongs the period of time needed to reach a critical mass of users having access to new functionality, particularly in software that is most useful when other users in a network also have access to the functionality.

### SUMMARY OF THE INVENTION

The present invention relates to automatically updating software components on a computer. The methods of the invention enable computer users to obtain incremental software updates as the upgraded software becomes available. The process of updating software components begins as a user computer accesses a data file that includes content data that is to be processed by the user computer. The data file includes component information that identifies software components that are recommended or required in order to process the content data and further includes version information identifying versions of the software components that are recommended or required.

The computer compares the component information and the version information with information specifying the components and versions of the components that are currently installed on the computer To the extent that the components currently installed at the computer do not coincide with the components and versions thereof that are required to process the content data, the methods of the invention enable the computer to obtain the appropriate versions of the software components. In particular, the computer then obtains an update table from a software server to identify network locations from which the software components can be obtained. The computer requests the software components not already installed on the computer from the identified network location or locations. The computer also requests from the identified network location or locations the new versions of software components if the current versions of the software components already installed on the computer are not sufficient to appropriately process the content data.

The processes of updating software components according to the invention are client-specific, in that a particular computer is caused to request only those software components and versions thereof that are not already installed on the computer. Thus, the time required to download the software components is minimal. This is in contrast to conventional methods of updating software, in which entire programs are downloaded without regard to specific software components that might be required to adequately process specific content data and also without regard to the identity and versions of any software components that might already be installed on the computer. The techniques according to the invention for updating software components are compatible with incremental changes to software programs, in which only one or a small number of software components are added or modified. In such cases, a client computer can automatically update its software components with little or no awareness of the process by the user of the computer.

While the methods of the invention can be used with substantially any type of software on computers or processing devices that communicate over networks, the benefits of the invention are particularly significant in the web content development industry and other areas in which the full utility of new software functionality is realized only when a critical mass of users has access to the functionality. For instance, as soon as a new feature is added to web development software and a corresponding new feature is added to browser software, the provider of the web content can immediately begin using the new feature without being concerned as to whether a critical mass of users yet has access to the corresponding new feature of the browser software. When web content is encoded using the new feature, the resulting data file includes component information and version information that is used by the client computer to determine that a software component providing the corresponding new feature of the browser software is to be automatically obtained. The client computer obtains the updated software component at the time that it is needed. Thus, the adoption of new features and functionality can be almost immediate, and the prolonged period required for such new features and functionality to be widely distributed to client computers can be substantially eliminated.

Additional features and advantages of the invention will be set forth in the description which follows, and in part will be obvious from the description, or may be learned by the practice of the invention The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings Understanding that these drawings depict only typical embodiments of the invention and are not therefore to be considered to be limiting of its scope, the invention will be described and explained with additional specificity and detail through the use of the accompanying drawings in which:

FIG. 1 illustrates a computer representing an exemplary operating environment in which aspects of the invention can be implemented;

FIG. 2 is a hardware block diagram depicting a user computer that communicates with other computers over a computer network;

FIG. 3 is a hardware block diagram illustrating a user computer that communicates with servers and other computers over a network;

FIG. 4 is a flow diagram illustrating a method according to the invention for automatically updating software components on a computer;

FIG. 5 is a flow diagram illustrating a method according to the invention for automatically updating software components on a computer and permitting the user to override the automatic updating of the software components;

FIG. 6 is a hardware and software block diagram showing a user computer that automatically receives appropriate software components from other computers over a network;

FIG. 7 illustrates exemplary data structures that may be used with embodiments of the invention to identify software components to be used to process data;

FIG. 8 is a flow diagram depicting a method of determining whether a computer is required to obtain software components in order to update software installed at the computer;

FIG. 9 illustrates an example whereby a computer determines whether software components are to be updated;

FIG. 10 is a flow diagram for identifying network locations from which required software components may be obtained; and

FIG. 11 illustrates an example whereby a computer identifies network locations from which required software components may be obtained.

### DETAILED DESCRIPTION OF THE INVENTION

The present invention relates to automatically updating software components on computers or other computing devices that communicate over networks. When the computer accesses a data file having content data that is to be processed by software, the computer performs acts for automatically determining which software components and versions thereof are required to process the data. The computer then accesses an update table indicating where the required software components and versions thereof that are not already installed on the computer can be obtained. The computer issues a request for these software components over the network, receives the components, and uses the components to process the content data.

1. Exemplary Computing Environment

As used herein, the term “computer” extends to any device or system that processes content data using software. Examples of computers include, but are not limited to, personal computers, hand-held devices, personal digital assistants, web telephones, portable music players, multi-processor systems, microprocessor-based or programmable consumer electronics, appliances and other machines or systems having embedded processors, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network.

As used herein, the term “data file” is to be broadly construed and extends to any data structure having content data that is to be processed by a computer. For example, data files can include image data, multimedia data, text data, executable code, or other types of content data. A data file can be a discrete document, all of which is obtained by the computer prior to being processed, or streaming data that is obtained by the computer, buffered, and processed sequentially. “Content data” represents the data in a data file that is to be processed, in contrast to the component information and version information, which are used by the computer to obtain the appropriate software components and versions thereof, as will be described herein.

As used herein, the terms “software component” and “component” refer to a software module, a library, or another functional part of a software program that can be added to or deleted from the software program, upgraded, or otherwise modified. The terms “install” and “installation” refer to a process whereby a software program or a software component is made operational at a computer. While conventional installation of a software component includes storing a copy of code associated with the software component in a non-volatile storage volume of the computer, installation according to the invention can also include providing a transient, operational copy of the software component without storing the software component in a non-volatile storage volume.

Embodiments within the scope of the present invention include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media. Computer-executable instructions comprise, for example, instructions and data which cause a general purpose computer, special purpose computer, or special purpose processing device to perform a certain function or group of functions.

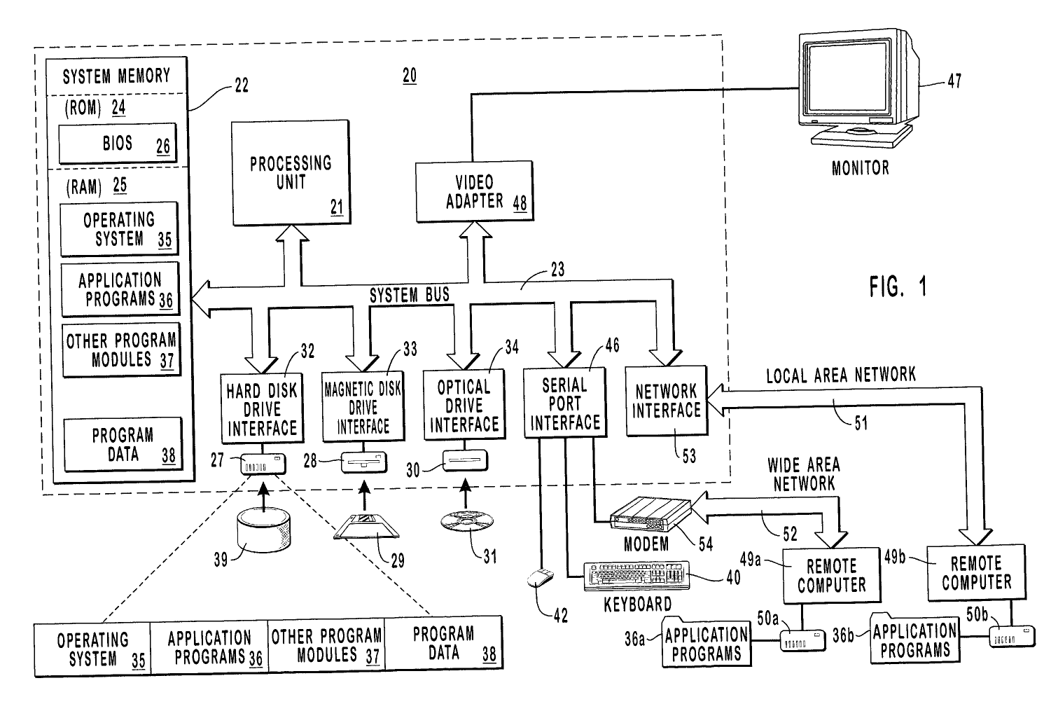

FIG. 1 and the following discussion are intended to provide a brief, general description of a suitable computing environment in which the invention may be implemented. Although not required, the invention will be described in the general context of computer-executable instructions, such as program modules, being executed by computers in network environments. Generally, program modules include routines, programs, objects, components, data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps. In a distributed computing environment, program modules may be located in both local and remote memory storage devices.

With reference to FIG. 1, an exemplary system for implementing the invention includes a general purpose computing device in the form of a conventional computer 20, including a processing unit 21, a system memory 22, and a system bus 23 that couples various system components including the system memory 22 to the processing unit 21. The system bus 23 may be any of several types of bus structures including a memory bus or memory controller, a peripheral bus, and a local bus using any of a variety of bus architectures. The system memory includes read only memory (ROM) 24 and random access memory (RAM) 25. A basic input/output system (BIOS) 26, containing the basic routines that help transfer information between elements within the computer 20, such as during start-up, may be stored in ROM 24.

The computer 20 may also include a magnetic hard disk drive 27 for reading from and writing to a magnetic hard disk 39, a magnetic disk drive 28 for reading from or writing to a removable magnetic disk 29, and an optical disk drive 30 for reading from or writing to removable optical disk 31 such as a CD-ROM or other optical media. The magnetic hard disk drive 27, magnetic disk drive 28, and optical disk drive 30 are connected to the system bus 23 by a hard disk drive interface 32, a magnetic disk drive-interface 33, and an optical drive interface 34, respectively. The drives and their associated computer-readable media provide nonvolatile storage of computer-executable instructions, data structures, program modules and other data for the computer 20. Although the exemplary environment described herein employs a magnetic hard disk 39, a removable magnetic disk 29 and a removable optical disk 31, other types of computer readable media for storing data can be used, including magnetic cassettes, flash memory cards, digital versatile disks, Bernoulli cartridges, RAMs, ROMs, and the like.

Program code means comprising one or more program modules may be stored on the hard disk 39, magnetic disk 29, optical disk 31, ROM 24 or RAM 25, including an operating system 35, one or more application programs 36, other program modules 37, and program data 38. A user may enter commands and information into the computer 20 through keyboard 40, pointing device 42, or other input devices (not shown), such as a microphone, joy stick, game pad, satellite dish, scanner, or the like. These and other input devices are often connected to the processing unit 21 through a serial port interface 46 coupled to system bus 23. Alternatively, the input devices may be connected by other interfaces, such as a parallel port, a game port or a universal serial bus (USB). A monitor 47 or another display device is also connected to system bus 23 via an interface, such as video adapter 48. In addition to the monitor, personal computers typically include other peripheral output devices (not shown), such as speakers and printers.

The computer 20 may operate in a networked environment using logical connections to one or more remote computers, such as remote computers 49a and 49b. Remote computers 49a and 49b may each be another personal computer, a server, a router, a network PC, a peer device or other common network node, and typically include many or all of the elements described above relative to the computer 20, although only memory storage devices 50a and 50b and their associated application programs 36a and 36b have been illustrated in FIG. 1. The logical connections depicted in FIG. 1 include a local area network (LAN) 51 and a wide area network (WAN) 52 that are presented here by way of example and not limitation. Such networking environments are commonplace in office-wide or enterprise-wide computer networks, intranets and the Internet.

When used in a LAN networking environment, the computer 20 is connected to the local network 51 through a network interface or adapter 53. When used in a WAN networking environment, the computer 20 may include a modem 54, a wireless link, or other means for establishing communications over the wide area network 52, such as the Internet. The modem 54, which may be internal or external, is connected to the system bus 23 via the serial port interface 46. In a networked environment, program modules depicted relative to the computer 20, or portions thereof, may be stored in the remote memory storage device. It will be appreciated that the network connections shown are exemplary and other means of establishing communications over wide area network 52 may be used.

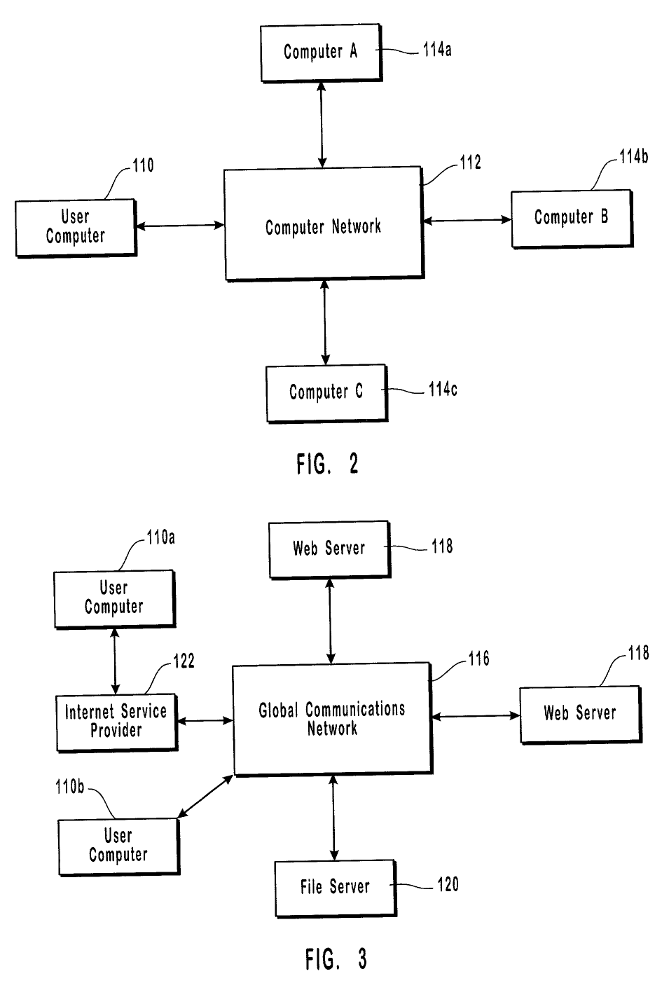

FIG. 2 illustrates a general configuration of elements that may be used with the embodiments of the invention described herein, in which a user computer 110 is connected to a computer network 112 and other computers 114a-c that communicate with the network. While FIG. 3 below illustrates use with the Internet, it will be appreciated by those skilled in the art that embodiments described herein may be used with intranets, local-area networks, wide-area networks, wireless networks, cellular networks, pager networks, an ad hoc network (e.g., a Bluetooth network defined by the industry consortium, Bluetooth SIG, Inc.), etc. In addition to user computer 110, a number of other computers 114a, 114b, and 114c are also in communication with computer network 112. These other computers may be similar to user computer 110, or they may be more specifically configured to act as servers. Those skilled in the art will appreciate that there are a number of means whereby a computer connected to a computer network may make resources of the particular computer available to other computers on the computer network. The general network architecture of FIG. 2 will be used herein to describe methods whereby user computer 110 obtains updated software components over computer network 112. Accordingly, user computer 110 can represent any other computer having software that is to be updated according to the invention.

FIG. 3 illustrates a more specific configuration of computers that may be used with the present invention. Typically, embodiments of the invention are disclosed herein in reference to a personal computer in electronic communication with a global communications network 116, which may be the Internet. A common use of the Internet is to browse the World Wide Web (the “web”). To browse the web, a person uses a computer 110 that operates browser software. Common browsers now available include Internet Explorer from Microsoft Corporation of Redmond, Washington, and Netscape Navigator from Netscape Communications Corporation, of Mountain View, Calif. Through the browser, the user requests web pages, streaming data, or other data files from servers, including web servers 118 or file servers 120. As shown in FIG. 3, some user computers 110a are directly connected to the Internet, while other user computers 110b use a modem to dial up an Internet Service Provider (“ISP”) 122 to access the Internet. It will be appreciated by those skilled in the art that there are various other means to connect to the Internet. For example, persons wishing to access the Internet may use a cable modem, DSL, an ISDN line, etc. As shown in FIG. 3, one or more servers 118, 120 may be connected to the Internet.

2. Updating Software Components

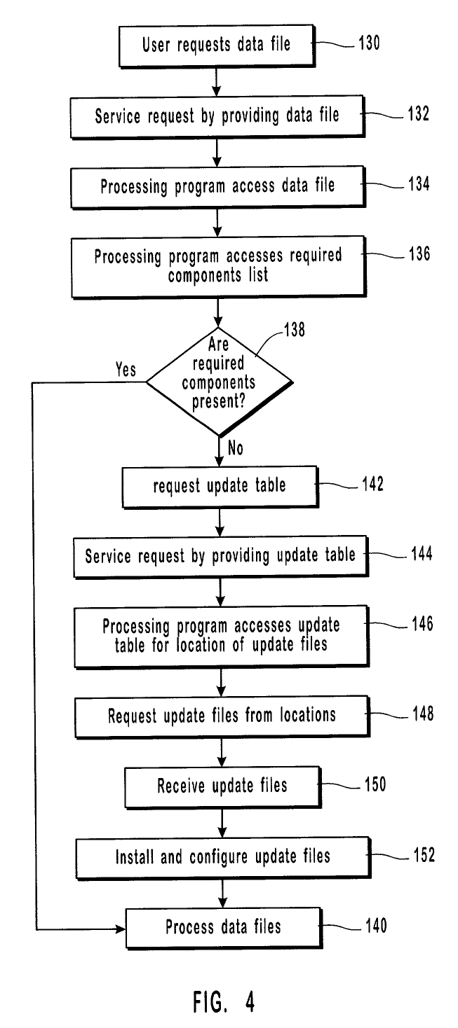

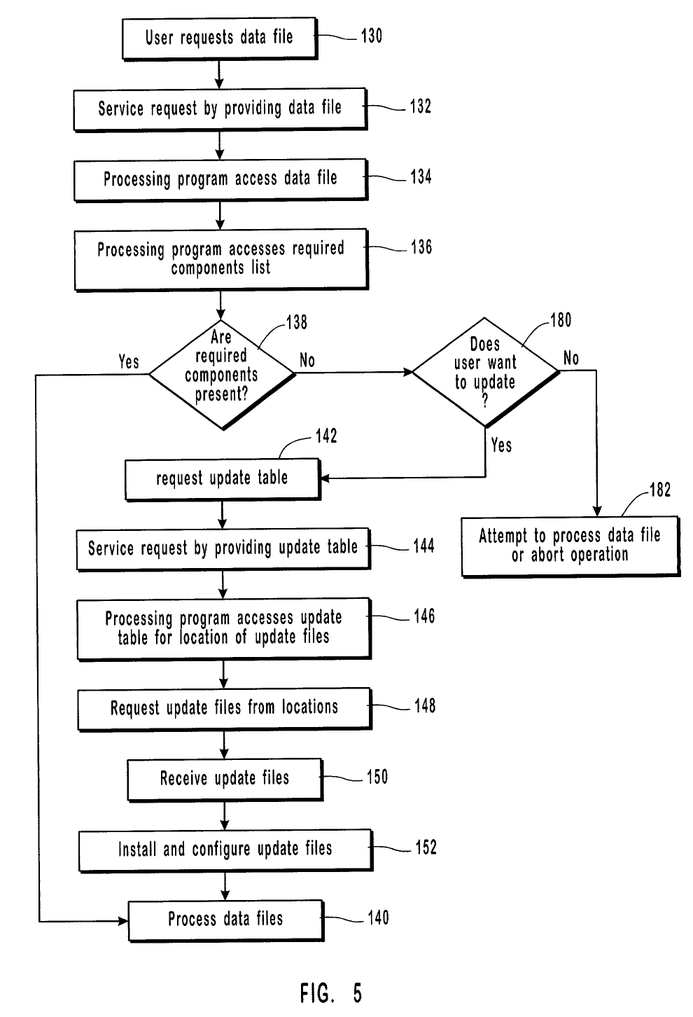

FIG. 4 illustrates a flow diagram of an embodiment of the invention by which a computer obtains software components used to process content data included in a data file. A user computer first requests a data file in step 130. This data file may be a Hypertext Markup Language (“HTML”) file from a web server, a file from a file server, a file from a File Transfer Protocol (“FTP”) server, a shared file on another user's computer, a file from another process running on the same computer, a file available to the computer across one or more networks, or the like. Another computer across a computer network receives the request and then services the request according to step 132 and sending the requested file to the user computer.

As the user computer receives the data file, a processing program accesses the data file in step 134. The processing program may be any computer program used to open, read or otherwise process the data file. For example, the processing program may be a web browser for HTML or Extensible Markup Language (“XML”) files, a word processor for text documents, an image viewer for images, a multimedia player for multimedia files, a music player for music files (e.g., an MP3 player), an application with the ability to process multiple general types of files, applications that start or open another program, the operating system itself, updates to the operating system, etc. In general, the processing program can be substantially any program that processes content data included in the data file.

As noted above, the present invention enables the user computer to obtain software components that are required to process the content data of the data file. Although the invention is generally described in reference to “required” software components, the term “required” should be interpreted to extend to software components that are merely recommended or suitable for optimizing the processing of content data. In contrast to conventional techniques for updating software, the method of FIG. 4 is client-specific, and enables the user computer to obtain only the versions of software components that are required for processing the content data and are not yet already installed at the computer.

Upon accessing the data file, the processing program reads a required component list from the data file in step 136. The required component list is a list embedded in the data file that indicates which components, modules, libraries and the like, need to be available to the processing program in order to properly process the file. The required component list is encoded in the data file by an entity that has generated the data file, such as a content provider, which, in the case of the web, could be a web developer. The required component list enables the content provider to specify the software components that should be used by the user computer to appropriately process the content data.

The processing program then determines whether the required components and the required versions thereof are installed on the user computer at decision block 138. Specific examples of determining whether the required components and the required versions thereof are installed on the user computer will be described in greater detail below. If the required components are present, the processing program processes the data file in step 140 without downloading new software components. It is noted that the processing program can process the data file in this manner without downloading new software components even if the processing program installed on the user computer is not the most recent version, so long as the specific software components and versions thereof required to process the data file are already installed at the user computer. For example, if the processing program is a browser, the browser software is not updated so long as the software components of the browser required to process the content data are up-to-date and already installed at the user computer. This enables the user to avoid spending the time that would otherwise be wasted in downloading an updated version of the entire browser software when the updated version is not presently needed.

If the required software components are not present, an update table is requested in step 142. Typically the update table is provided by the vendor or developer of the required component. For example, if the required software component were a component of a particular word processor, the update table would typically be provided and made available by the vendor or developer of the word processor. In the embodiment of FIG. 3, the processing program has embedded in its program code or configuration files a location on the computer network from which the update table is to be requested. Alternatively, the location on the computer network from which the update table is to be requested can be determined at runtime as will be further described below. The request for the update table is automatically sent to a computer on the computer network without user assistance or intervention. The computer on the network receives the request and services the request by sending the update table to the user computer in step 144.

According to an embodiment of the invention, the update table includes a list of available components for the particular processing program that may be required to process content data of particular files. In addition, locations of the available components are included in the update table. As illustrated at step 146, the user computer accesses the update table, identifies the particular components in the update table that need to be acquired, and then extracts the locations of the required components. Once the locations are known, the user computer requests the specific components from the location or locations in step 148. The components that need to be updated may be located at one computer, typically a server, on the computer network, or they may be located at various and different computers.

Once the required updates have been received by the user computer in step 150, they are then installed and configured, if necessary in step 152. In this manner, the user computer obtains the software components that are required to appropriately process the content data of the data file. It is noted that, according to the embodiment of the invention described in reference to FIG. 4, when the user computer does not initially have the required component and versions thereof, the user computer requests and downloads only those components that are required to process the content data. Unlike conventional software upgrade techniques, user computers according to the invention do not need to download an entire upgraded software program (e.g., an entire updated browser) if only one or a few upgraded software components of the software program are needed, which can significantly reduce the time associated with updating the software. Thus, the present invention is particularly suited for incremental upgrades of software.

When the required software components are installed, the content data of the data file is processed. Depending on the nature of the processing program and the content data, the content data may be processed in a way that is perceptible by the user (e.g., displayed, shown, played, etc.) or in a way that is not directly or immediately perceived by the user.

Although the processes disclosed herein can be automatic in the sense that they can proceed without any direct user assistance or intervention, the methods can also be adapted to enable users to override the software update. FIG. 5 illustrates an alternative embodiment wherein a user may choose not to have the required software components updated. The flow diagram and the associated method of FIG. 5 are substantially identical to those of FIG. 4, with the following exceptions. As shown, once the required component list is obtained in step 136, and if the required version of the required components is not available according to decision block 138, the user is prompted as to whether he or she wants to update the required software components. If the user desires to have the components updated according to decision block 80, the process of updating the require software components continues as otherwise described in steps 142-152 of FIGS. 4 and 5. If the user does not wish to update the files, the method of FIG. 5 proceeds to step 182, in which the user computer attempts to process the content data of the data file without the required software components of the required versions thereof or aborts the operation.

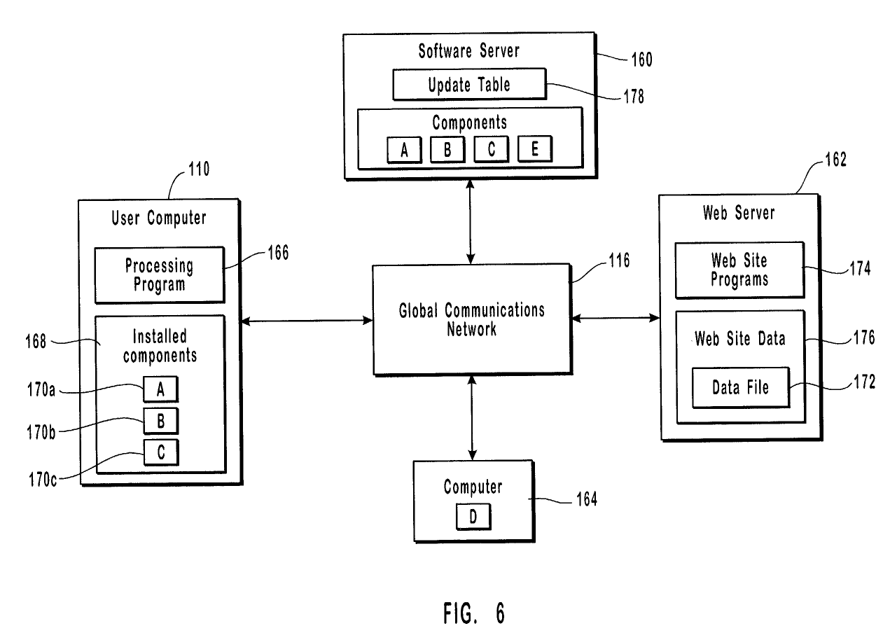

FIG. 6 illustrates a specific example of a user computer 110, computer network 116 and server computers 160, 162 and 164 are used to provide updated software components to the user computer according to the method described above in reference to FIG. 4. The user computer 110 includes processing program 166 and its installed components 168. The installed components 168 shown in FIG. 6 are components A, B and C (170a-c, respectively). In this example, it is assumed that component A 170a has a version number 2, component B 170b has a version number 4, and component C 170c has a version number 1. In the example of FIG. 6, the processing program 166 is assumed to be a browser. The installed components 168 may be items such as shared libraries, software modules, dynamically-linked libraries (DLL's), plug-ins, etc.

In this example, browser 166 requests a particular data file 172 from a web server 162 across the computer network 116. Web server 162 includes web site programs 174 and web site data 176, which includes the particular data file 172 requested by user computer 110. The data file 172 includes the required component list. Table 1, below, illustrates the information that can be included a required components list used with the embodiment of the invention of FIG. 4 and the specific example provided in reference to FIG. 6. It is noted that the “tables” presented herein represent examples of the data structures that can be used to specify information, and the term “tables” extend to all such data structures, regardless of their format.

TABLE 1
Required Component List

| Component | Version Number | Location Code |
|---|---|---|
| A | 2 | Software Server 160 |
| B | 6 | Software Server 160 |
| C | 1 | Software Server 160 |
| D | 1 | Software Server 160 |
| E | 2 | Software Server 160 |

The foregoing example of a required component list has three fields, namely, a component field, a version number field, and a location code field. The information included in the component field is designated herein as “component information,” which sets forth the software components that are required to appropriately process content data of data file 172 of FIG. 6. In this example, the “publisher” of the content data, which may be a content provider, the administrator of web server 162, or another entity, has determined that the processing program that processes data file 172 should use components A, B, C, D and E. The component information can be formatted to represent a file name or another name of the required software components or to include any other information that identifies the required components. The component information included in the component field allows the user computer 110 to determine the identity of the required software components.

The information included in the version number field is designated as “version information,” which sets forth the required version of the required software components. In some instances, software components do not have versions or version numbers, or the version is not important to the proper processing of content data, in which case, the required component list does not need to include a version number field or the version number field can include wildcard values. The values included in the version number field can be numbers or have another format that identifies the required version. In this example, the publisher of the content data has determined that the processing program that processes data file 172 should use versions 2, 6, 1, 1 and 2 of software components A, B, C, D and E, respectively.

The location code field, if included in the required component list, specifies a network location at which an update table can be obtained. Update tables and the functions thereof are described in greater detail below A location code field is used primarily when the various required software versions are obtained from different sources or vendors and the update tables associated with the different software components are located at different software servers. In situations in which a single software server or a default software server is used to provide an update table for all required software components, location field may be omitted from the required components list.

In this example, the location codes included in the location code field indicate that an update table associated with required software components A, B, C, D and E can be obtained at network locations represented by software server 160. In other examples, different update tables may be required for different software components, in which case the location codes in the location code field would have different values. The location code can have any format, such as that of a Uniform Resource Identifier (“URI”) that uniquely identifies network locations where the update tables can be obtained.

User computer 110, when it receives data file 172, opens the data file and accesses the required component list included therein. By comparing the component information and the version information with information identifying the software components and versions thereof currently installed at user computer 110, the user computer determines whether it already has the software components and the required versions or whether the required software components and required versions need to be acquired.

In the present example, user computer 110 determines that it does not have all the necessary components to process the content data of data file 172. Specifically, user computer 110 determines that it does not yet have components D and E, and that the currently installed version 4 of software component B is different from the required version 6.

Once user computer 110 determines which software components and versions thereof are to be obtained, the user computer performs acts to determine network locations from which it can download the required software components. Thus, user computer 110 requests from software server 160 an update table 178, which specifies the network locations from which the required software components can be obtained. If the network location of update table 178 is not specified by a location code in the location code field of the required component list, the network location of the update table may be found in other ways, such as through broadcasting or advertising across computer network 116 or using hard-coded information in processing program 166. Table 2, below, illustrates the information that can be included in an update table according to the example presented in FIG. 6.

TABLE 2
Update Table

| Component | Location |
|---|---|
| A | Software Server 160 |
| B | Software Server 160 |
| C | Software Server 160 |
| D | Computer 164 |
| E | Software Server 160 |

The update table indicates that components A, B, C, D and E are available and that components A, B, C and E are available from software server 160. The update table also indicates that component D is available from another computer associated with computer network 116, namely, computer 164. User computer 110 examines the update table received from software server 160 and extracts the locations of the needed components, which include components D and E (i.e., the required components not yet installed at user computer 110) and component B (i.e., the component having a required version not yet installed at user computer 110). The user computer 110 then requests the required versions of software components B and E from software server 160 and the required version of software component D from the computer 164. In this example, user computer 110 does not request components A or C, because the required versions of these components are already installed at the user computer.

The user computer 110 installs and configures the required software components when the required software components are received. Once user computer 110 has installed and configured the required software components, it can properly process the content data of data file 172. It is noted that the process of updating specific software components described herein allows user computer 110 to automatically determine which software components and versions thereof are needed and identify the network location of such software components automatically and without direct user assistance or intervention. If the specific software components required to process the content data of data file 172 are already installed at user computer 110, the user computer foregoes downloading any updated versions of software components that are not required to process the content data. Moreover, the process of updating software component is client-specific, in that the user computer obtains updated versions of only those software components that are needed to process the data without necessarily downloading an entire software program (e.g., an entire browser).

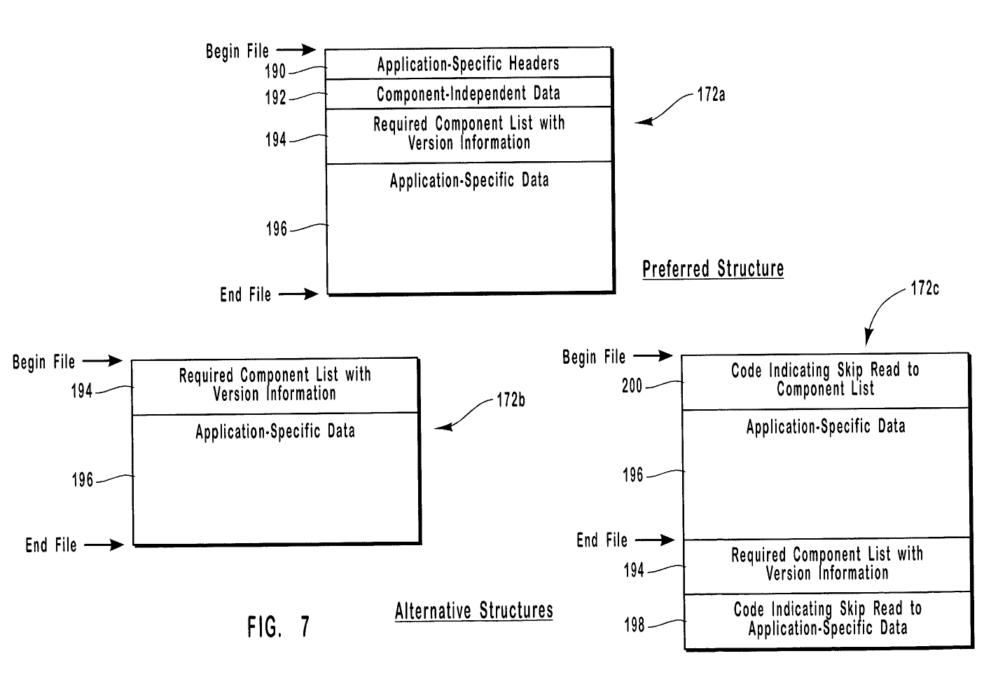

FIG. 7 illustrates embodiments of the data file structure. As shown in data file 172a, application specific headers 190 may be included in the first block of the data file. These headers may include items such as file type, version information, format information, etc. Component-independent data 192 may also be included in the data file structure. Component-independent data 192 may include items such as document identification, descriptions, data that can be processed by the basic processing program, data that may be processed in place of component-specific data, etc. As illustrated, the required component list 194 is also included in the data file structure. This required component list 194, one example of which has been presented in Table 1, indicates all the components and the versions thereof that are necessary to properly process the content data of the data file. The component- or application-specific data 196 is also located in data file 172a. The application-specific data represents the content data which is to be processed by the required software components.

In addition to illustrating a presently preferred data file structure, FIG. 7 also depicts alternative data file structures that may be used with embodiments of the invention disclosed herein. As shown at data file 172b, one alternative is to simply include two blocks of data, the required component list 194 and the component-specific data 196. A further alternative, shown at data file 172, is to include the required component list 194 at the end of the file rather than at the beginning. Such structure may require certain codes 198 and 200 to direct the processing program to the appropriate place in the data file 172c for the required information.

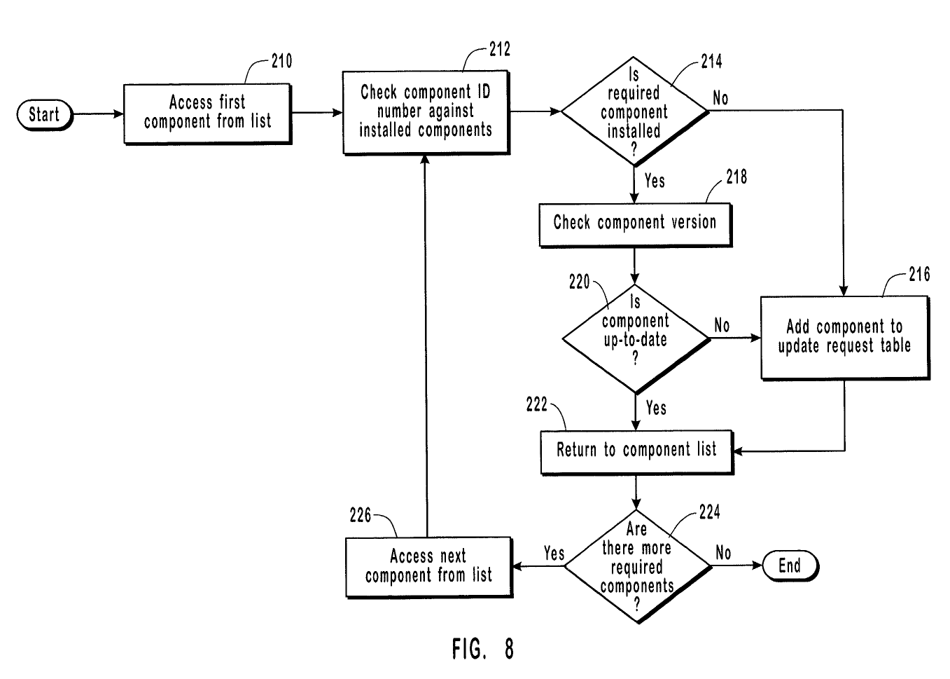

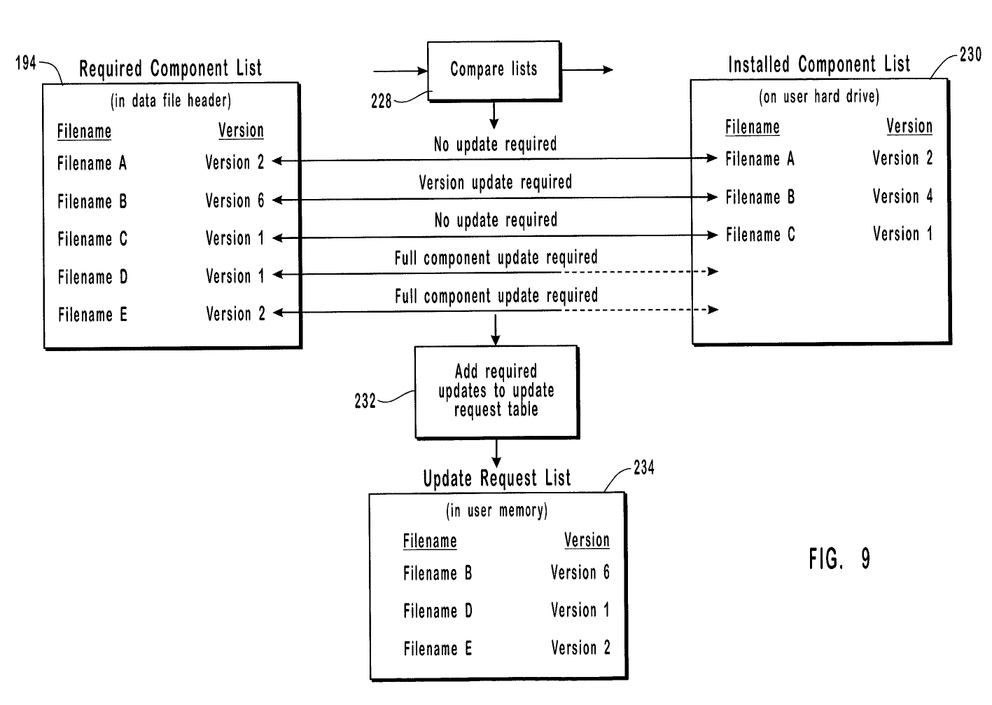

FIGS. 8 and 9 illustrate the portions of the methods of the invention that relate to determining which software components are to be updated at a computer based on a required component list and the identity and version of software components already installed at the computer. FIG. 8 is a flow diagram that illustrates the comparison of the required component list with the software components that are already installed on the user computer. The first software component in the list is accessed in step 210. The system then determines whether that component is already installed by comparing the component information identifying the required software component with information identifying the installed software components in step 212.

If the component is not already installed according to decision block 214, the component may be added to an update request table in step 216, which is used to keep track of the required software components that are to be updated. An example of an update request table is illustrated and described in greater detail below in reference to FIG. 9. If, however, the component is already installed, its version is compared with the required version specified in the required component list in step 218. If the version of the installed software is not up-to-date according to decision block 220, the method advances to step 216, in which the required software component is added to the update request table. If the version of the installed software component is up-to-date according to decision block 220, the system returns to the required component list for the next component listed at step 222. If, according to decision block 224, another required software component is included in the required component list, the method proceeds to step 226, in which the next required software component in the required component list is accessed. Steps 212-224 are repeated as necessary for the next required software component.

FIG. 9 illustrates how an update request table can be compiled. As described above in reference to FIG. 8, the required component list 194 is compared (228) with an installed component list 230 to determine whether all required software components and required versions thereof are already installed or whether the software components are to be updated. Any required software components that need to be updated are added (232) to an update request table 234. The update request table 234 is typically stored locally at the user computer and is used by the user computer during the software updating process to keep track of the required software components and the required versions thereof that are to be obtained. The list may be stored in memory, on the hard drive of the user computer, on a remote storage device, etc.

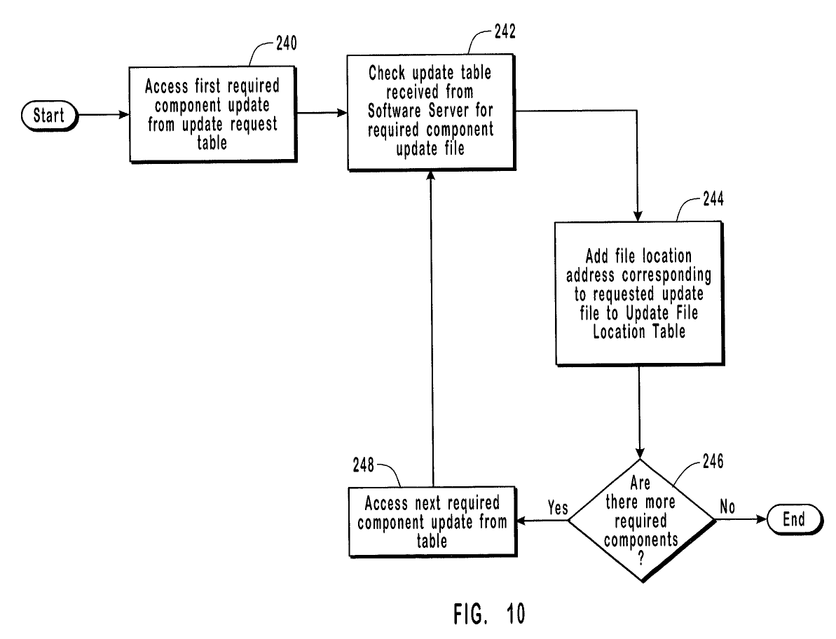

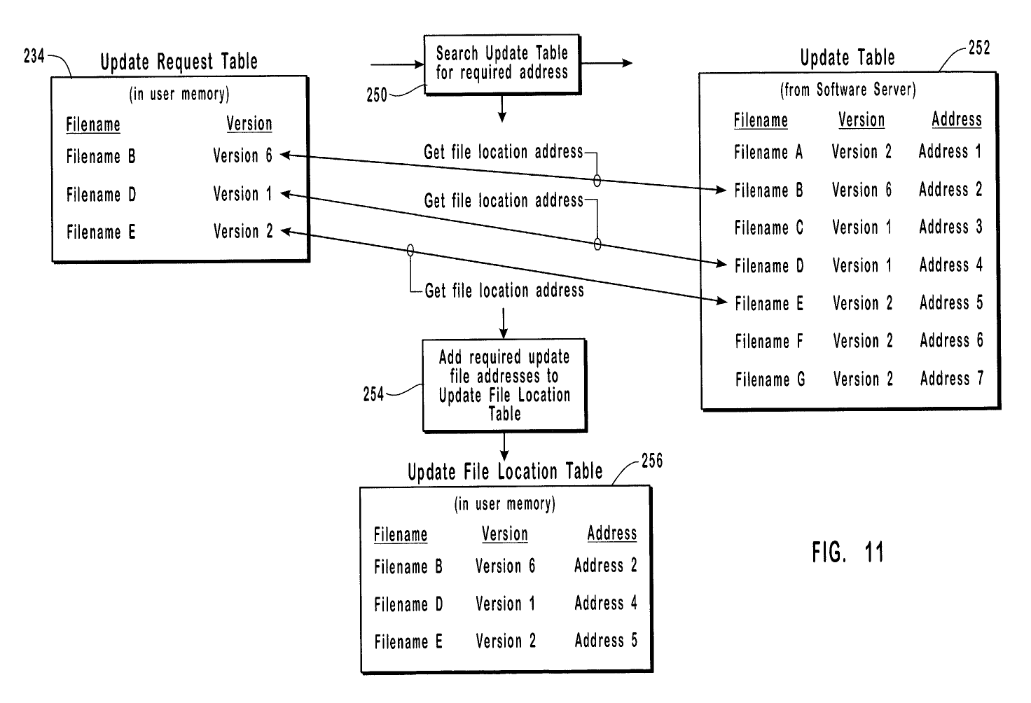

In the example of FIG. 9, which is similar to the example presented above in reference to FIG. 6 and Tables 1 and 2, the user computer determines that no update is required of software components A and C, as the required versions of these software components are already installed at the user computer. The user computer determines that version 4 of software component B is to be updated to the required version 6. The user computer also determines that the required software components D and E are not yet installed and that these software components are to be obtained. This information is then stored in update request table 234 for future reference during the process of updating these software components as will be described in reference to FIGS. 10 and 11.

FIGS. 10 and 11 illustrate the portions of the methods of the invention that relate to identifying network locations from which required software components can be obtained based on an update table received from a software server and the update request table created as described above in reference to FIGS. 8 and 9. FIG. 10 illustrates the extraction of the network locations or addresses of the required software components using the update request table. The first required software component in the update request table is accessed in step 240 and this required software component is then looked up, as shown in step 242, in the update table received from the software server (e.g., software server 160 of FIG. 6). Once the required software component is found in the update table, the network location or address from which the required software component can be acquired is added to an update file location table in step 244. The update file location table is used during the process of updating the required software components to keep track of the network locations of such required software components . Once the network location or address has been extracted, it is determined, according to decision block 246, whether the update request table includes more required software components to be updated. If so, the method proceeds to step 248, in which the next required software component is processed.

FIG. 11 illustrates a specific example of a process of creating an update file location table, as discussed in relation to FIG. 10. As set forth above, update request table 234 is used to look up the required software components in update table 252 to determine (250) the locations or addresses for the required software component. These locations are added (254) to an update file location table 256, which is then used to request the specific software components needed.

Once the updated software components are acquired, they are installed and configured, as needed, so that the updated software components can be used to process the content data of the data file. Techniques for installing and configuring the required software components are based largely on the nature of the software components and the computer on which they are to be installed. Because the techniques for installing and configuring the required software components will be understood by those skilled in the art, these techniques are not critical to the invention.

3. Exemplary Data Structures

Table 1 above illustrates generally the type of information that can be included in a required component list and Table 2 illustrates generally the type of information that can be included in an update table. While a variety of formats can be used to construct required component lists and update tables according to the invention, the following discussion relates to specific data structures for designating required software components and required versions thereof and for specifying network locations where such required software components can be obtained.

Tables 3A and 3B define a data structure that represents a required component list and further defines the format of values that can be stored in the data fields of the data structure. As discussed above, the required component list is incorporated into the data file that is accessed by the computer and defines the required software components and the required versions thereof that are needed to appropriately process the content data of the data file.

TABLE 3A
Component Table
Count of Component Entries (N)
Component Entry 1
Component Entry 1
. . .
Component Entry N

As shown above, the component table, which corresponds generally to the required component list illustrated in Table 1, includes a count of component entries and a number of component entries equal to the count. The count of table entries defines a number (N), which corresponds to the number of component entries. Each component entry defines a software component and a version thereof required to process the content data of the data file that includes the required component list defined in Tables 3A-3E.

The format of the component entries is defined in Table 3B:

TABLE 3B
Component Entry Format
Component Code
Version Code

Thus, each component entry in a component table includes a component code and a version code. The component code identifies the required software component, while the version code identifies the required version of the software component. Accordingly, the component code and the version code represent examples of the component information and the version information that are included in the required component list and specify the required software components and the required versions thereof. The component codes can be file names or have another data format that identifies the software component, while the version code can have a text, numeric, or other string data format that identifies the version.

Using the foregoing data structures and data formats, the computer that receives a data file including the required component list can begin the process of obtaining the required software components and the required versions thereof to appropriately process content data included in the data file.

The update table, which is used to specify network locations from which the computer can request required versions of required software components, is further defined below by Tables 4A-4E. Table 4A shows that the update table includes a server location table, which designates the servers from which the computer can obtain software components and further includes a component location table, which links the particular required software components with the servers from which they can be obtained.

TABLE 4A
Update Table
Server Location Table
Component Location Table

The server location table of Table 4A is further defined below in reference to Tables 4B and 4C.

TABLE 4B
Server Location Table
Count of Location Entries (N)
Location Entry 1
Location Entry 2
. . .
Location Entry N

Table 4B shows that the server location table includes a count of location entries and location entries equal in number to the count. Table 4C further defines the information included in a location entry.

TABLE 4C
Location Entry Format
Server Location Code
Explicit Network Location

Table 4C shows that the location entries of Table 4B include a server location code that is used in the component location entries of the component location table (Tables 4D and 4E, below) and has a numeric data format. Each location entry specifies a server address (e.g., an explicit network location), from which the computer is to obtain a required version of a required software component. When the software components are obtained by the computer using the Internet, the server addresses can be Uniform Resource Identifiers.

The component location table illustrated in Table 4A is further defined by Table 4D below.

TABLE 4D
Component Location Table
Count of Component Location Entries (N)
Component Location Entry 1
Component Location Entry 2
. . .
Component Location Entry N

The component location table of Table 4D includes a count of component location entries and a series of component location entries equal in number to the count. As will be shown below in reference to Table 4E, each component location entry relates to a specific one of the software components that are to be updated at the computer. The information included in the component location entries is as follows:

TABLE 4E
Component Location Entry Format
Component Code (compare with Table 3B)
Server Location Code (pointer to Table 4C)
Specific Location

The component code of the component location entry is used by the computer to match a particular component location entry (Table 4E) with the corresponding component entry (Table 3B). The computer matches the component code of Table 4E with the component code of Table 3B to determine that the component location entry is one that is to be used to obtain a required software component. The computer then uses the server location code of Table 4E as a pointer to the appropriate location entry (Table 4C) in the server location table (Table 4B). In this manner, the computer can identify the specific server address and use the address to obtain the required software component. For instance, the computer may determine that to obtain a particular software component, a request should be sent to http://<<address>>, by identifying this server address in the explicit network location field of the location entry defined by Table 4C.

As shown in Table 4E, the component location entry format can firther include a specific location having a value with a string format that is appended to the explicit network location to obtain the required software component. For example, the specific location field of Table 4E could specify that the value “/components/new/viewer” is to be appended to the explicit network location http://<<address>> to obtain the complete network address of the software component, http://<<address>>/components/new/viewer.

The present invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. Al changes that come within the meaning and range of equivalency of the claims are to be embraced within their scope.

What is claimed and desired to be secured by United States Letters Patent is:

1. In a computer that communicates with other computers over a network, a method for automatically updating software components at the computer, the method comprising the acts of:
accessing a data file, wherein the data file includes:
content data; and
component information and version information specifying required software components and required versions thereof that are to be used to process the content data;
comparing the component information and the version information with software components installed at the computer and identifying a required version of a required software component that is not yet installed at the computer;
requesting and receiving the required version of the required software component from one of said other computers; and
using the required version of the required software component to process the content data.

2. The method of claim 1, further comprising the act of receiving the data file from a server associated with the network.

3. The method of claim 1, wherein the act of identifying a required version of a required software component that is not yet installed at the computer comprises the act of determining that no version of the required software component is installed at the computer.

4. The method of claim 1, wherein the act of identifying a required version of a required software component that is not yet installed at the computer comprises the act of determining that a previous version of the required software component is installed at the computer.

5. The method of claim 1, further comprising the act of installing the updated component files.

6. The method of claim 1, further comprising the act of receiving the data file, wherein:
the data file is received from a source external to the computer;
the data file is a web document; and
the required software component includes functionality associated with a feature of a web browser operating at the computer.

7. The method of claim 1, further comprising the act of identifying a network location from which the required version of the required software component is to be received.

8. The method of claim 7, wherein the act of identifying the network location comprises the act of requesting and receiving from a first computer associated with the network an update table that specifies the network location.

9. The method of claim 1, further comprising the acts of:
determining that a required version of another required software component is already installed at the computer; and
processing the content data with the required version of said other required software component already installed at the computer without requesting or receiving the required version of said other software component from any other computer associated with the network.

10. The method of claim 1, wherein the act of requesting and receiving the required version of the required software component is conducted without requesting or receiving an updated copy of an entire software program that includes both the required version of the required software component and other required software components.

11. The method of claim 1, wherein the component information and the version information are encoded in the data file by a publisher of the data file, the data file having been generated by the publisher using development software that includes functionality corresponding to the functionality of the required version of the required software component that is requested and received from said other computer.

12. In a computer that communicates with other computers over a network, a method for automatically updating software components of a processing program at the computer so that the updated software components can be used to process content data of a data file, the method comprising the acts of:
opening the data file using the processing software, wherein the data file includes:
content data; and
component information and version information specifying required software components and required versions thereof that are to be used to process the content data;
comparing the component information and the version information with data identifying software components already installed at the client computer and versions of the installed software components;
based on the act of comparing, identifying a required version of a required software component that is not yet installed at the computer;
requesting an update table from another computer associated with the network, wherein the update table specifies a network location from which the required version of the required software component can be obtained;
receiving the requested update table;
based on the update table, identifying said network location from which the required version of the required software component can be obtained;
requesting the required version of the required software component from the network location;
receiving the required version of the required software component from the network location; and
installing the required version of the required software component, thereby updating the software components of the processing software such that the required version of the required software component can be used to process the content data.

13. The method of claim 12, wherein at least some of the computers are server computers, the method further comprising the act of receiving the data file from one of the server computers.

14. The method of claim 13, wherein at least one of the server computers is a software server related to the processing program of the client computer.

15. The method of claim 14, wherein the act of receiving the data file comprises the act of receiving a web document from one of the server computers, wherein the processing program is a web browser and the required version of the required software component is associated with the web browser.

16. The method of claim 14, wherein the act of requesting the update table comprises the act of requesting the update table from the software server.

17. The method of claim 16, further comprising the act of sending the update table requested from the software server through the network to the computer.

18. The method of claim 12, further comprising the step of sending the required version of the required software component from the network location to the computer through the network.

19. The method of claim 12, wherein the network is a global communications network.

20. The method of claim 12, wherein the act of identifying a required version of a required software component that is not yet installed at the computer comprises the act of determining that no version of the required software component is yet installed at the computer.

21. The method of claim 12, wherein the act of identifying a required version of a required software component that is not yet installed at the computer comprises the act of determining that a previous version of the required software component has already been installed at the computer.

22. A computer program product for implementing, in a computer that communicates with other computers over a network, a method for automatically updating software components at the computer, the computer program product comprising:
a computer-readable medium carrying computer-executable instructions that, when executed, cause the computer to perform the method, wherein the method comprises the acts of
accessing a data file, wherein the data file includes:
content data; and
component information and version information specifying required software components and required versions thereof that are to be used to process the content data;
comparing the component information and the version information with software components installed at the computer and identifying a required version of a required software component that is not yet installed at the computer;
requesting and receiving the required version of the required software component from one of said other computers; and
using the required version of the required software component to process the content data.

23. The computer program product of claim 22, wherein the act of identifying a required version of a required software component that is not yet installed at the computer comprises the act of determining that no version of the required software component is installed at the computer.

24. The computer program product of claim 22, wherein the act of identifying a required version of a required software component that is not yet installed at the computer comprises the act of determining that a previous version of the required software component is installed at the computer.

25. The computer program product of claim 22, wherein the required version of the required component is associated with browser software that operates at the computer and processes the content data.

26. The computer program product of claim 22, wherein the method further comprises the act of installing the required version of the required software component after the required version of the required software component is received at the computer.

27. A system of networked computers that is capable of automatically updating software components of a processing program of a computer included in the system so that the updated software components can be used to process content data of a data file, the system comprising
a computer, wherein the computer includes a memory module which stores software components of the processing program that are used to process the data file;
a plurality of servers with memory modules that store updated software components, wherein one of the plurality of servers is a software server with a memory module that stores a table of available updated software components related to the processing program and the network locations from which the updated software components can be obtained, wherein the computer uses a communication module to interface with the plurality of servers;
a communication network that connects the computer with the plurality of servers; and
processing means at the computer for:
comparing component information and version information of a data file specifying required software components and required versions thereof that are to be used to process content data included in the data file with software components installed at the computer and identifying a required version of a required software component that is not yet installed at the computer; and
automatically obtaining the required version of the required software component from a network location specified in said table.

28. The system of claim 27, wherein the processing means for automatically obtaining the required version of the required software component comprise processing means for:
creating a list of the required version of the required software component and any other required versions of other required software components;
obtaining the table of available updated software components;
requesting the required version of the required software component from the network location specified in said table;
receiving the required version of the required software component; and
installing the required version of the required software component such that the processing program can use the required version of the required software component to process the content data of the data file.

29. The system of claim 27, wherein the network locations from which the updated software components can be obtained are associated with addresses of the plurality of servers.

30. A system for automatically updating software components of a processing program of a computer system so that the updated software components can be used to process content data of a data file, the system comprising:
means for opening a data file, wherein the data file includes:
content data; and
component information and version information specifying required software components and required versions thereof that are to be used to process the content data;
means for reading the component information and the version information;
means for logically comparing the component information and the version information with the software components already installed at the computer to determine whether any required version of any required software component is not yet installed at the computer;
means for requesting from a source external to the computer said any required version of said any required software component that is not yet installed at the computer;
means for receiving said any required version of said any required software components sent by the source; and
means for installing said any required version of said any required software component such that the computer can use updated versions of the required software components to process the content data.

31. The system of claim 30, further comprising means for receiving the data file from a computer associated with the network.

32. The system of claim 30, further comprising means for identifying a network location associated with said source external to the computer from which at least one of said any required versions of said any software components can be obtained.

33. The system of claim 30, wherein the means for logically comparing is capable of comparing the component information and the version information with data identifying software components already installed at the client computer and versions of the installed software components. - Page 47 - Docket No. 15402.1
